(19) United States
(12) Patent Application Publication
(10) Pub. No.: US 2009/0128042 A1
(43) Pub. Date: May 21, 2009

(54) GOLD OR SILVER PLATED WIRE LEADS ON CHRISTMAS LIGHTS

(75) Inventor: John L. Janning, Bellbrook, OH (US)

Correspondence Address: DICKSTEIN SHAPIRO LLP, 1825 EYE STREET NW, Washington, DC, 20006-5403, US

(73) Assignee: JLJ. Inc.

(21) Appl. No.: 12/358,109

(22) Filed: Jan. 22, 2009

Related U.S. Application Data
(60) Provisional application No. 61/204,314, filed on Jan. 5, 2009.

(51) Int. Cl. H05B 37/00

(52) U.S. Cl. 315/122

(57) ABSTRACT

The electrical wire leads of miniature lights or LED's in a series-wired Christmas light string are gold or silver plated to resist corrosion. The wire leads of any shunt components used in the sockets of the light string can also be plated for corrosion resistance.

This application claims the benefit of U.S. Provisional Application Ser. No. 61/204,314, filed Jan. 5, 2009.

### BACKGROUND OF THE INVENTION

This invention relates to Christmas light strings, and more specifically, to miniature light bulbs and light emitting diodes (LED's) used in Christmas light strings. The bulbs in these light strings are wired in electrical series connection with just a few volts dropped across each for illumination. When subjected to moisture, especially when operated outdoors, corrosion in the socket can affect electrical conductivity and cause the series-wired light string to malfunction. This is especially true when such lights are operated on DC voltage such as LED's.

Although, when operated at 120 volts AC, a potential of approximately 170 peak volts may appear across a bulbs wire lead to a socket electrode, this sometimes is not enough to cause a breakdown and restore continuity. In some light strings where semiconductor or resistor shunts are used, the peak voltage across a bulb may be only around five volts or less. Breakdown with such a low voltage is unlikely.

Accordingly, it would be desirable to provide a Christmas tree light string which is resistant to corrosion.

### SUMMARY OF THE INVENTION

The present invention fulfills the above need by providing a corrosion resistant miniature light or LED series-wired light string in which the electrical leads of the LED's or miniature bulbs of the light string are gold or silver plated. The wire leads of any shunt components used in the light string sockets can also be plated to provide further corrosion resistance.

Other features and advantages of the present invention will become more apparent from the detailed description of exemplary embodiments provided below with reference to the accompanying drawings.

### BRIEF DESCRIPTION OF THE DRAWINGS

FIG. 1 shows a Christmas light string comprising a number of LED's or miniature lights connected in a series-wired arrangement with shunts; FIGS. 1a-1f show various shunts that can be used in the light string; and FIGS. 1g and 1h show a miniature incandescent bulb and an LED, respectively, that can be used in the light string.

FIG. 2 shows a Christmas type miniature light bulb with gold or silver plated wire leads.

FIG. 3 illustrates a shunt device as it is inserted in the Christmas light string socket.

### DETAILED DESCRIPTION OF THE PREFERRED EMBODIMENTS

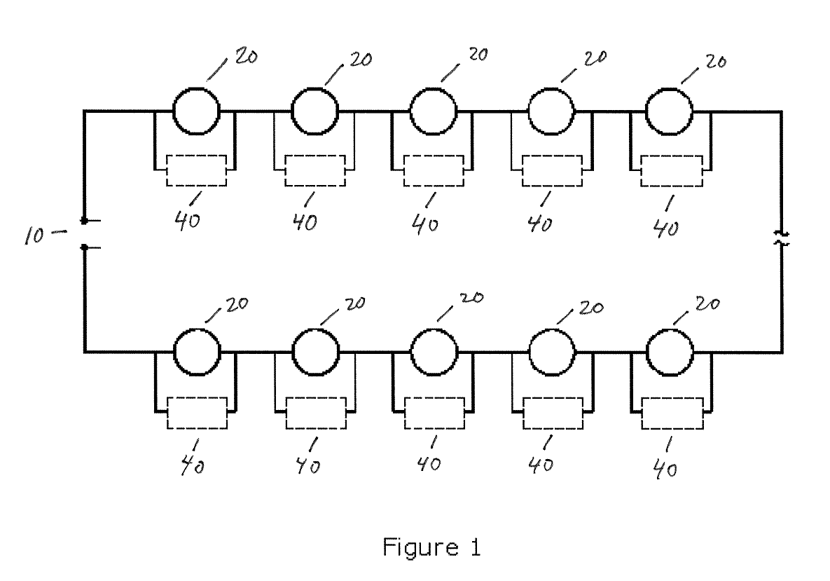

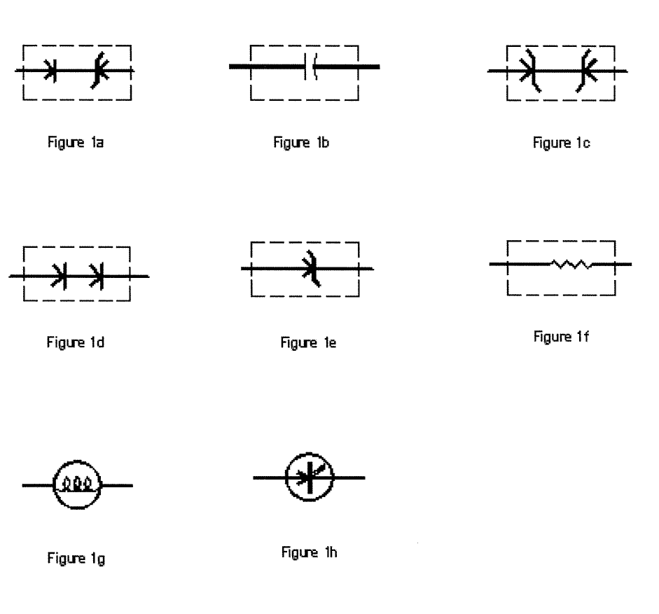

FIG. 1 shows a Christmas light string comprising a number, usually 35 or 50, lights 20 disposed in sockets connected in series with a power source 10. The lights can be miniature incandescent bulbs (FIG. 1g) or LED's (FIG. 1h). To maintain current flow in the series-wire light string in the event of a failure of a light, each light can be provided with a shunt 40, which can be a simulated diode array formed of a rectifier diode in series with a Zener diode—back-to-back, common cathode (FIG. 1a), a capacitor (FIG. 1b), a pair of back-to-back (common cathode) Zener diodes (FIG. 1c), a single Zener diode (FIG. 1e), or a resistor (FIG. 1f).

To resist corrosion, the wire leads of the LED's or miniature lights in the light string are plated, in accordance with the invention, with a layer of gold or silver. For gold plating, a gold layer—preferably 24 karat gold—having a two to six microinch thickness is plated over the miniature light or LED electrical wire leads. For silver plating, the thickness is about a micron (about 40 microinches). The plating can be applied using any conventional method know by those skilled in the art, such as by plating the wire leads of the LED's or miniature lights by electroless means.

If the LED or miniature lights are shunted as shown in FIG. 1, the wire leads of the shunt can also be gold or silver plated in the same manner as the LED or bulb electrodes are plated. As mentioned above and as shown in FIGS. 1a-1f, the shunt can be comprised of resistors, semiconductors and capacitors.

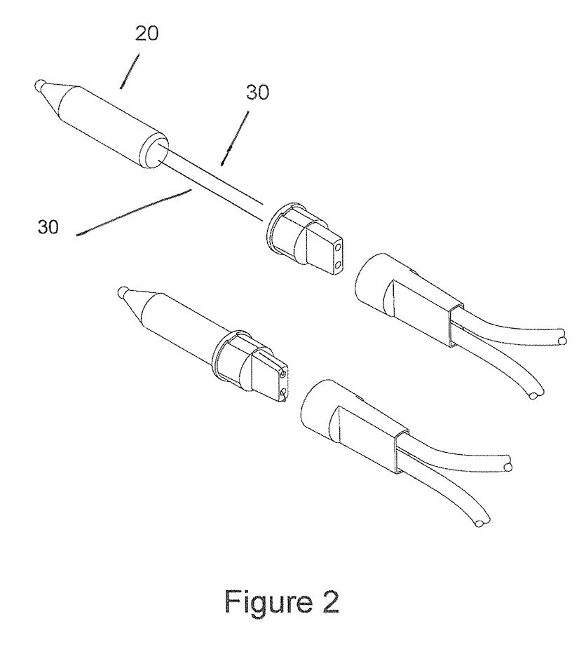

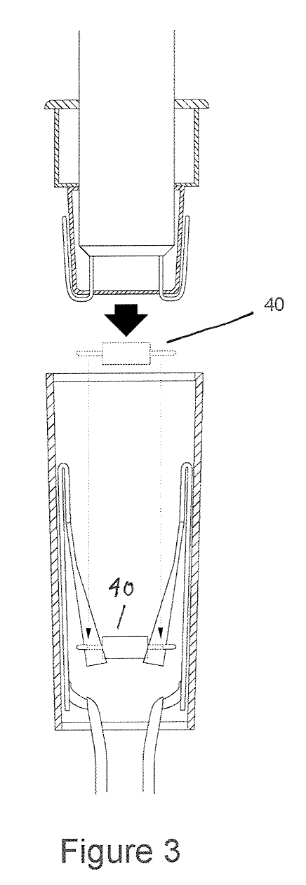

FIG. 2 shows a Christmas type miniature light bulb, 20, with gold plated wire leads, 30. FIG. 3 illustrates a shunt device 40, as it is inserted in the Christmas light string socket.

The teachings in this invention are intended to cover the gold or silver plating by any means onto electrical wire terminations or other terminations of shunt devices connected in parallel with the lamps in a series-wired light string and such plating onto the electrical lead wires of the LED's or miniature bulbs used in such series connected light strings. If gold plating is used, as mentioned above. 24 karat gold plating is preferred, although a lesser amount of gold in an alloy is acceptable. It may also be desired to manufacture the miniature light bulbs and/or LED's using gold or silver plated wire in the manufacturing process. In so doing, a lower (karat) gold content could be used. However, the gold content should never go below 40% (approximately 10 karat).

Although the invention has been described in detail in connection with the exemplary embodiments, it should be understood that the invention is not limited to the above disclosed embodiments. Rather, the invention can be modified to incorporate any number of variations, alternations, substitutions, or equivalent arrangements not heretofore described, but which are commensurate with the spirit and scope of the invention. Accordingly, the invention is not limited by the foregoing description or drawings, but is only limited by the scope of the appended claims.

What is claimed is:

1. A light string comprising a plurality of series-wired light emitting devices connected to a power source, the light emitting device having wire terminals plated with gold or silver.

2. The light string of claim 1, wherein the light emitting device is an incandescent miniature light bulb.

3. The light string of claim 1, wherein the light emitting device is a light emitting diode (LED).

4. The light string of claim 1, wherein the power source is 120 volts AC.

5. The light string of claim 1, wherein the power source is rectified AC to direct current.

6. The light string of claim 2, further comprising a shunt device electrically connected across the incandescent miniature light bulb.

7. The light string of claim 6, wherein the electrical wire terminals of the shunt device are gold or silver plated.

8. The light string of claim 7, wherein the shunt device is a resistor.

9. The light string of claim 7, wherein the shunt device is a Zener diode.

10. The light string of claim 7, wherein the shunt device consists of back-to-back Zener diodes.

11. The light string of claim 1, wherein the gold plating thickness is more than one hundred Angstroms.

12. The light string of claim 1, wherein the gold plating thickness is two to six microinches.

13. The light string of claim 1, wherein the silver plating thickness is on the order of one micron.

14. The light string of claim 3, wherein a shunt device is electrically connected across the light emitting diode (LED).

15. The light string of claim 14, wherein the shunt device has electrodes plated with gold or silver.

16. The light string of claim 15, wherein the shunt device is a capacitor.
